(19) United States
(12) Patent Application Publication
(10) Pub. No.: US 2024/0044030 A1
(43) Pub. Date: Feb. 8, 2024

(54) THREE-DIMENSIONAL PRINTING DEVICE USING SELECTIVE ELECTROCHEMICAL DEPOSITION

(71) Applicant: ANYCASTING CO., LTD., Seoul (KR)

(72) Inventors: Sungbin KIM, Seoul (KR); Kunwoong KO, Seoul (KR); Donghyeon LEE, Incheon (KR)

(73) Assignee: ANYCASTING CO., LTD., Seoul (KR)

(21) Appl. No.: 18/266,796

(22) PCT Filed: Dec. 21, 2020
(86) PCT No.: PCT/KR2020/018839

§ 371 Date: Jun. 12, 2023

(51) Int. Cl. C25D 1/00; B33Y 30/00; C25D 21/12; B33Y 50/02

(52) U.S. Cl. CPC C25D 1/003; B33Y 30/00; C25D 21/12; B33Y 50/02

(57) ABSTRACT

The present invention relates to a three-dimensional printing device using selective electrochemical deposition and particularly to a three-dimensional printing device capable of selectively depositing metal materials onto a substrate by using additive manufacturing by electrochemical deposition (electrochemical additive manufacturing, ECAM).

### TECHNICAL FIELD

The present disclosure relates to a three-dimensional (3D) printing device using selective electrochemical deposition, and more particularly to a 3D printing device for selectively stacking a metal raw material on a substrate using electrochemical additive manufacturing (ECAM) using electrochemical deposition.

### BACKGROUND ART

Three-dimensional (3D) printing technology uses additive manufacturing, which stacks materials such as polymeric materials, plastics, or metal powder, based on three-dimensional design data, to shape physical models, prototypes, tools, and parts.

As a 3D printing method, liquid-based and powder-based methods are mainly used depending on the characteristics of a raw material used. In the liquid-based method, layers are stacked one by one according to a shape of an object using polymer synthetic resin in a liquid state and then the stacked structure is photocured. In the powder-based method, a metal raw metal made in the form of powder is melted or sintered.

There among, a 3D printer using polymers or plastics as a raw material is implemented in a liquid-based method and is widely used, but the 3D printer using a metal raw material is not widely used unlike the 3D printer using a plastic raw material for reasons such as high material prices, complicated processing methods, high sintering temperatures, and explosion hazards in that it is difficult to implement the 3D printer using a metal raw material in a liquid-based method and is implemented only in a powder-based method.

As the cited references to resolve this problem, Korean Patent No. 10-1774383 (registration publication date: Aug. 29, 2017) and Korean Patent No. 10-1774387 (registration publication date: Aug. 29, 2017) and Korean Patent No. 10-1913171 (registration publication date: Oct. 24, 2018) disclose a “3D printing device using selective electrochemical deposition”.

However, since the 3D printing device according to the cited references basically use an electrochemical method, there is a problem in that a stacking speed is slow.

### DISCLOSURE

### Technical Problem

The present disclosure basically resolves conventional problems.

An embodiment of the present disclosure provides a three-dimensional (3D) printing device for selectively stacking a metal raw material on a substrate using an electrochemical additive manufacturing (ECAM) method.

An embodiment of the present disclosure provides a 3D printing device for increasing a printing speed using a multi-electrode module including a plurality of electrodes.

An embodiment of the present disclosure provides a 3D printing device for improving stacking quality by removing air bubbles generated during electrochemical electrodeposition.

An embodiment of the present disclosure provides a 3D printing device for multi-stacking using a multi-electrode module including a plurality of electrodes.

An embodiment of the present disclosure provides a 3D printing device for uniform stacking during multi-stacking using a multi-electrode module including a plurality of electrodes.

An embodiment of the present disclosure provides a 3D printing device for multi-stacking or single-stacking in various forms using a multi-electrode module including a plurality of electrodes.

### Technical Solution

To achieve the above purposes, a three-dimensional (3D) printing device according to an embodiment of the present disclosure includes a tub accommodating an electrolyte, a substrate placed in a state of being immersed in the electrolyte accommodated in the tub, an electrode holder, a multi-electrode module including a plurality of electrodes arranged and fixed at predetermined intervals on the electrode holder, a driver configured to adjust movement of the multi-electrode module, a power supply configured to supply power to the substrate and the plurality of electrodes, and a controller configured to control the driver and the power supply to selectively electrodeposit and stack metal ions included in the electrolyte on the substrate

In the 3D printing device according to an embodiment of the present disclosure, the plurality of electrodes may pass through the electrode holder, and bottom surfaces of the plurality of electrodes may be level with a bottom surface of the electrode holder.

The 3D printing device according to an embodiment of the present disclosure may further include a storage configured to store an electrolyte, and an electrolyte feeder configured to supply the electrode stored in the storage to the tub, wherein the electrode holder includes an inlet into which the electrolyte supplied from the electrolyte feeder flows, an outlet through which the electrolyte supplied from the electrolyte feeder flows is ejected to the substrate, and an ejection flow path connecting the inlet and the outlet, wherein the ejection flow path is inclined such that when the electrolyte introduced through the inlet is ejected through the outlet, the electrolyte is ejected toward a region in which the plurality of electrodes is provided.

The 3D printing device according to an embodiment of the present disclosure may further include a storage configured to store an electrolyte, and an electrolyte feeder configured to supply the electrode stored in the storage to the tub, wherein the electrode holder includes an inlet into which the electrolyte supplied from the electrolyte feeder flows, an outlet formed on a bottom surface of the electrode holder and formed between the plurality of electrodes to eject the electrolyte introduced through the inlet to the substrate, and an ejection flow path connecting the inlet and the outlet.

In the 3D printing device according to an embodiment of the present disclosure, the outlet may include a main outlet formed on a central part of a region in which the plurality of electrodes is provided, a peripheral outlet formed around the main outlet, and a main inlet connected to the main outlet may be formed on a top surface of the electrode holder and formed on the central part of the region in which the plurality of electrodes is provided, and a peripheral inlet connected to the peripheral outlet may be formed on a side surface of the electrode holder.

In the 3D printing device according to an embodiment of the present disclosure, the power supply may include a power source, a substrate connector connecting the power source to the substrate, a main connector connecting the power source to the plurality of electrodes, and a sub connector connecting the main connector to each of the plurality of electrodes.

In the 3D printing device according to an embodiment of the present disclosure, the sub connector may be provided such that the plurality of electrodes are arranged in parallel to each other.

In the 3D printing device according to an embodiment of the present disclosure, the sub connector may include a resistance element.

In the 3D printing device according to an embodiment of the present disclosure, a resistance value of the resistance element may have a greater value than a resistance value between the substrate and bottom surfaces of the plurality of electrodes.

In the 3D printing device according to an embodiment of the present disclosure, a resistance value of the resistance element may have a value in a range of 5 to 15 times the resistance value between the substrate and the bottom surfaces of the plurality of electrodes.

In the 3D printing device according to an embodiment of the present disclosure, the resistance value between the substrate and the bottom surfaces of the plurality of electrodes may have a value in a range of 50 to 200Ω, and the resistance value of the resistance element may have a value in a range of 250 to 3,000Ω.

In the 3D printing device according to an embodiment of the present disclosure, the sub connector may include a first switching part selectively connecting the main connector and the electrodes.

In the 3D printing device according to an embodiment of the present disclosure, at least one of the plurality of electrodes may include a plurality of electrodes having bottom surfaces with different sizes, and a sub connector connecting the at least one of the plurality of electrodes to the main connector may include a second switching part connecting any one of the plurality of electrodes having bottom surfaces with different sizes to the main connector.

In the 3D printing device according to an embodiment of the present disclosure, the sub connector may include a resistance element.

In the 3D printing device according to an embodiment of the present disclosure, the multi-electrode module may be provided in a plural number, and the power supply may include a power source, a substrate connector connecting the power source to the substrate, a main connector connecting the power source to the plurality of electrodes, a first sub connector connecting the main connector to each of the plurality of electrodes, and a second sub connector connecting the first sub connector to each of the plurality of electrodes.

In the 3D printing device according to an embodiment of the present disclosure, the first sub connector may be provided such that the plurality of multi-electrode modules are arranged in parallel to each other, and the second sub connector may be provided such that the plurality of electrodes are arranged in parallel to each other.

In the 3D printing device according to an embodiment of the present disclosure, the first sub connector may include a third switching part configured to selectively connect the main connector and the multi-electrode module.

In the 3D printing device according to an embodiment of the present disclosure, the second sub connector may include a first switching part configured to selectively connect the first sub connector and the electrode.

In the 3D printing device according to an embodiment of the present disclosure, the second sub connector may include a resistance element.

In the 3D printing device according to an embodiment of the present disclosure, at least one of the plurality of electrodes may include a plurality of electrodes having bottom surfaces with different sizes, and a second sub connector connecting the at least one of the plurality of electrodes to the first sub connector may include a second switching part connecting any one of the plurality of electrodes having bottom surfaces with different sizes to the first sub connector.

### Advantageous Effects

An embodiment of the present disclosure provides a three-dimensional (3D) printing device for selectively stacking a metal raw material on a substrate using an electrochemical additive manufacturing (ECAM) method.

An embodiment of the present disclosure provides a 3D printing device for increasing a printing speed using a multi-electrode module including a plurality of electrodes.

An embodiment of the present disclosure provides a 3D printing device for improving stacking quality by removing air bubbles generated during electrochemical electrodeposition.

An embodiment of the present disclosure provides a 3D printing device for multi-stacking using a multi-electrode module including a plurality of electrodes.

An embodiment of the present disclosure provides a 3D printing device for uniform stacking during multi-stacking using a multi-electrode module including a plurality of electrodes.

An embodiment of the present disclosure provides a 3D printing device for multi-stacking or single-stacking in various forms using a multi-electrode module including a plurality of electrodes.

The effects according to the present disclosure are not limited to the effects mentioned above, and other effects not mentioned are to be clearly understood by those skilled in the art to which the present disclosure belongs from the claims and the detailed description.

### DESCRIPTION OF DRAWINGS

FIG. 1 is a diagram schematically showing a three-dimensional (3D) printing device according to an embodiment of the present disclosure.

FIG. 2 is a diagram schematically showing a state in which power is applied to a substrate and an electrode.

FIG. 3 is a diagram showing a top surface of a multi-electrode module.

FIG. 4 is a diagram illustrating a bottom surface of a multi-electrode module.

FIG. 5 is a schematic cross-sectional view of a multi-electrode module according to another embodiment of the present disclosure.

FIG. 6 is a diagram showing a top surface of the multi-electrode module of FIG. 5.

FIG. 7 is a diagram showing a bottom surface of the multi-electrode module of FIG. 5.

FIG. 8 is a diagram schematically showing a power supply according to another embodiment of the present disclosure.

FIG. 9 is a diagram for explaining an effect of the power supply of FIG. 8.

FIG. 10 is a diagram schematically illustrating a power supply according to another embodiment of the present disclosure.

FIG. 11 is a schematic diagram of an electrode according to another embodiment of the present disclosure.

### BEST MODE

Embodiments will now be described more fully with reference to the accompanying drawings. In the description of the drawings, the same elements are denoted by the same reference numerals, and a repeated explanation thereof will not be given.

The terms such as “first” and “second” are used herein merely to describe a variety of constituent elements, but the constituent elements are not limited by the terms. The terms are used only for the purpose of distinguishing one constituent element from another constituent element.

When a certain part “includes” a certain component, this indicates that the part may further include another component instead of excluding another component unless there is no different disclosure.

The thickness or size of each layer (film), region, pattern, or structure in the drawing may be modified for clarity and convenience of description, and thus it does not entirely reflect the actual size. In the description of the embodiments, each layer (film), region, pattern or structures may be “over”, “on” or “below” the substrate, each layer (film), region, pad, or patterns. In the case of being described as being formed “over”, “on” and “under”, the “over”, “on” and “under” may include those formed “directly” or “indirectly”.

In addition, “on” means to be located above or below a target member, and does not necessarily mean to be located at the top with respect to a direction of gravity.

In this specification, relative terms such as ‘upper’, ‘lower’, ‘top’, ‘bottom’, ‘upper’, and ‘lower’ are used to describe a relationship between components based on a direction shown in the drawings, and the present disclosure is not limited by such terms.

Embodiments may be implemented independently or together, and some components may be excluded in accordance with the purpose of the present disclosure.

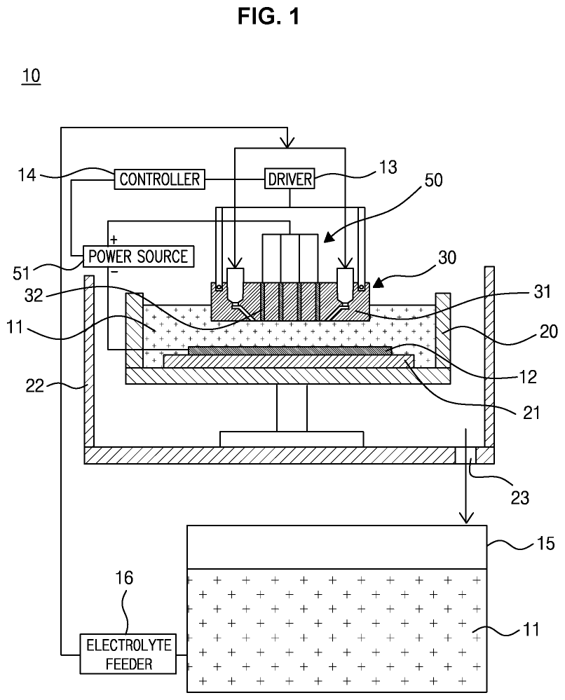

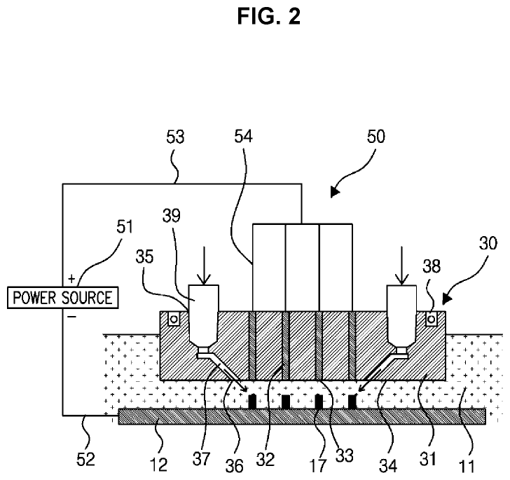

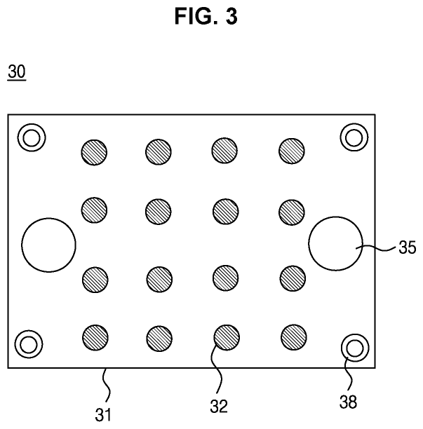

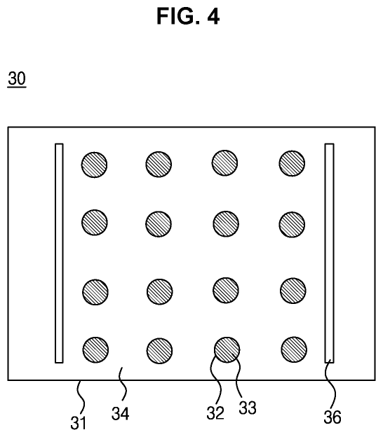

FIG. 1 is a diagram schematically showing a three-dimensional (3D) printing device according to an embodiment of the present disclosure, FIG. 2 is a diagram schematically showing a state in which power is applied to a substrate and an electrode, FIG. 3 is a diagram showing a top surface of a multi-electrode module, and FIG. 4 is a diagram illustrating a bottom surface of a multi-electrode module.

Referring to FIGS. 1 to 4, a 3D printing device 10 according to an embodiment of the present disclosure may include a tub 20 accommodating an electrolyte 11, a substrate 12 placed in an immersed state in the electrolyte 11 accommodated in the tub 20, a multi-electrode module 30 including an electrode holder 31 and a plurality of electrodes 32 arranged and fixed at predetermined intervals to the electrode holder 31, a driver 13 controlling movement of the multi-electrode module 30, a power supply 50 supplying power to the substrate 12 and the plurality of electrodes 32, and a controller 14 controlling the driver 13 and the power supply 50 and selectively electrodepositing and stacking metal icons included on the electrolyte 11 on the substrate 12.

The substrate 12 and the bottom surfaces 33 of the plurality of electrodes 32 may face each other, may be spaced apart from each other by a predetermined distance, and may be immersed in the electrolyte 11 accommodated in the tub 20.

For example, the substrate 12 may be immersed in the electrolyte 11 accommodated in the tub 20 while being placed on the support 21 provided in the tub 20, and the bottom surfaces 33 of the plurality of electrodes 32 may be immersed in the electrolyte 11 accommodated in the tub 20 according to movement of the multi-electrode module 30 by an operation of the driver 13 and may be spaced apart from the substrate 12 by a predetermined distance.

In the state in which the substrate 12 and the bottom surfaces 33 of the plurality of electrodes 32 face each other at a predetermined interval and are immersed in the electrolyte 11 accommodated in the tub 20, when the controller 14 may control the power supply 50 to control the plurality of electrodes 32 to (+) and the substrate 12 to (−) to apply power to the substrate 12 and the plurality of electrodes 32, metal icons included in the electrolyte 11 may be stacked on the substrate 12 while being electrochemically deposited on a region 17 of the substrate 12, which faces the bottom surfaces 33 of the electrodes 32.

Accordingly, the controller 14 may control the driver 13 and the power supply 50 to selectively electrodeposit and stack metal ions included in the electrolyte 11 on the substrate 12.

The driver 13 is a component for controlling movement of the multi-electrode module 30, and may drive the multi-electrode module 30 in horizontal and vertical directions.

For example, the driver 13 moves the multi-electrode module 30 horizontally to select a stacking position of the substrate 12. After stacking is performed at a predetermined height, for example, after one predetermined layer is completely stacked, a distance between the substrate 12 and the bottom surfaces 33 of the plurality of electrodes 32 may be adjusted by moving the multi-electrode module 30 in a vertical direction by approximately a height at which the one layer is stacked.

That is, the driver 13 may drive the multi-electrode module 30 to adjust a 3D displacement including a gap between the substrate 12 and the bottom surfaces 33 of the plurality of electrodes 32.

The power supply 50 may be provided to simultaneously apply power to the plurality of electrodes 32.

In detail, the power supply 50 may include a power source 51, a substrate connector 52 connecting the power source 51 to the substrate 12, a main connector 53 connecting the power source 51 to the plurality of electrodes 32, and a sub connector 54 connecting the main connector 53 and each of the plurality of electrodes.

Here, the sub connector 54 may be provided to arrange the plurality of electrodes in parallel.

Accordingly, when power is applied by the power supply 50, power may be applied to the plurality of electrodes 32 at the same time. Then, as shown in FIG. 2, each of the plurality of electrodes 32 is simultaneously multi-layered, thereby increasing the overall printing speed.

The multi-electrode module 30 is a component for fixing the plurality of electrodes 32 and may include the electrode holder 31 in which the plurality of electrodes 32 are arranged and fixed at predetermined intervals.

In addition, the plurality of electrodes 32 may be fixed in a state of penetrating the electrode holder 31, and in this case, the bottom surfaces 33 of the plurality of penetrating electrodes 32 may be placed horizontally with respect to a bottom surface 34 of the electrode holder 31.

When electrochemical deposition occurs if power is applied to the substrate 12 and the plurality of electrodes 32, air bubbles are generated. Since these air bubbles interfere with stable electrochemical deposition and degrade stacking quality, it is necessary to smoothly remove the generated air bubbles in order to improve the stacking quality.

However, when the bottom surfaces 33 of the plurality of penetrating electrodes 32 are placed inward from the bottom surface 34 of the electrode holder 31 to form a predetermined space or protrude beyond the bottom surface 34 of the electrode holder 31, the generated air bubbles may not be smoothly removed while staying in the space or sticking to a portion of the protruding electrode 32.

Therefore, in order to improve the stacking quality, the bottom surfaces 33 of the plurality of electrodes 32 may be level with the bottom surface 34 of the electrode holder 31.

The electrode holder 31 may be made of a plastic material, and the multi-electrode module 30 may be manufactured by immerging the electrode holder 31 made of plastic in water at a temperature higher than room temperature to ensure ductility, and then press-inserting the plurality of electrodes 32 into the electrode holder 31 having the ensured ductility at predetermined intervals.

In this case, the bottom surfaces 33 of the plurality of electrodes 32 and the bottom surface 34 of the electrode holder 31 may be leveled by polishing the entire bottom surface 34 of the electrode holder 31.

The 3D printing device 10 according to an embodiment of the present disclosure may be configured to smoothly remove the generated bubbles.

To this end, the 3D printing device 10 may include a storage 15 storing the electrolyte 11 therein, and an electrolyte feeder 16 for feeding the electrolyte 11 stored in the storage 15 to the tub 20.

The electrolyte feeder 16 may be used with any pump. However, the present disclosure is not limited thereto, and the electrolyte 11 stored in the storage 15 may be fed to the tub 20 using a height difference.

The electrode holder 31 may include an inlet 35 into which the electrolyte supplied from the electrolyte feeder 16 flows, an outlet 36 through which the electrolyte introduced through the inlet 35 is ejected to the substrate 12, and an ejection flow path 37 connecting the inlet 35 and the outlet 36.

As shown in FIG. 2, the ejection flow path 37 may be inclined such that when the electrolyte introduced through the inlet 35 is ejected through the outlet 36, the electrolyte is ejected toward a region in which the plurality of electrodes is provided.

Then, when power is applied to the substrate 12 and the plurality of electrodes 32 and electrochemical deposition occurs, air bubbles generated may be smoothly removed.

As shown in FIG. 4, the outlet 36 may be formed on the bottom surface 34 of the electrode holder 31 and may be formed long at one side of an edge of a region in which the plurality of electrodes 32 are provided. Then, the generated air bubbles may be removed more smoothly.

The inlet 35 may be formed in a top surface of the electrode holder 31, the inlet 35 may be coupled with nozzles 39 that eject the electrolyte supplied from the electrolyte feeder 16 at a predetermined pressure, and a coupler 38 for fixing to the driver 13 may be formed on the top surface of the electrode holder 31.

The 3D printing device 10 according to an embodiment of the present disclosure may include an auxiliary tub 22 accommodating the tub 20.

The auxiliary tub 22 may be provided with a discharge 23 for discharging electrolyte overflowing from the tub 22 to the storage 15.

Then, the electrolyte overflowing from the tub 20 may be accommodated in the auxiliary tub 22 and then discharged to the storage 15 through the discharge 23.

Therefore, when the electrolyte feeder 16 is used as a predetermined pump, the electrolyte 11 may circulate through the tub 20 and the storage 15 by the electrolyte feeder 16 and the discharge 23.

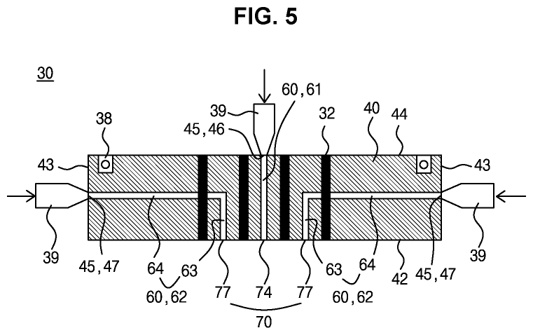

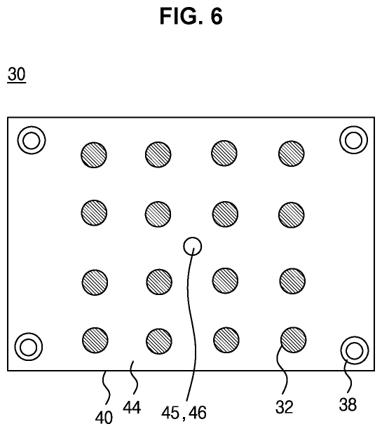

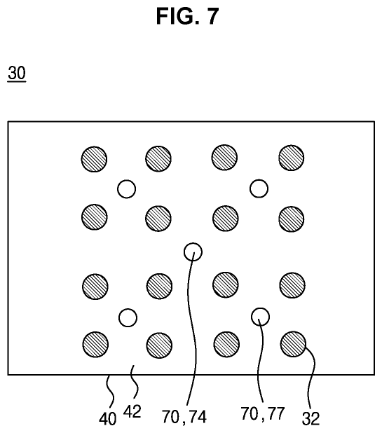

FIG. 5 is a schematic cross-sectional view of a multi-electrode module according to another embodiment of the present disclosure, FIG. 6 is a diagram showing a top surface of the multi-electrode module of FIG. 5, and FIG. 7 is a diagram showing a bottom surface of the multi-electrode module of FIG. 5.

Referring to FIGS. 5 to 7, an electrode holder 40 of the multi-electrode module 30 according to the present embodiment may include an inlet 45 into which the electrolyte supplied from the electrolyte feeder 16 flows, an outlet 70 formed on a bottom surface 42 of the electrode holder 40 and formed between the plurality of electrodes 32 to eject the electrolyte flowing through the inlet 45 into the substrate 12, and an ejection flow path 60 connecting the inlet 45 and the outlet 70.

As such, when the outlet 70 is provided between the plurality of electrodes 32, air bubbles generated during electrochemical electrodeposition occurs when power is applied to the substrate 12 and the plurality of electrodes 32 are more effectively removed.

The inlet 45 may be coupled with the nozzles 39 that eject the electrolyte supplied from the electrolyte feeder 16 at a predetermined pressure.

In addition, the outlet 70 may include a main outlet 74 formed at a central part of an area in which the plurality of electrodes 32 are provided.

For example, when the outlet 70 is provided with one, the outlet 70 may include the main outlet 74, and when a plurality of the outlet 70 is provided between the plurality of electrodes 32, the outlet 70 may include the main outlet 74 and a peripheral outlet 77 formed around the main outlet 74.

As such, when the outlet 70 includes the main outlet 74, the generated air bubbles may be removed more effectively.

In addition, a main inlet 46 connected to the main outlet 74 may be formed on a top surface 44 of the electrode holder 40 and formed in a central part of an area having the plurality of electrodes 32, and a peripheral inlet 47 connected to the peripheral outlet 77 may be formed on a side surface 43 of the electrode holder 40.

Then, the nozzles 39 may be easily coupled to each of the main inlet 46 and the peripheral inlet 47. This is because, since a sub connector 54 connected to each of the plurality of electrodes 32 needs to be provided on the top surface 44 of the electrode holder 40, when both the main inlet 46 and the peripheral inlet 47 are formed on the top surface, it is not easy to couple the nozzles 39 to each of the main inlet 46 and the peripheral inlet 47.

At this time, a main ejection flow path 61 connecting the main outlet 74 and the main inlet 46 is formed vertically, and a peripheral ejection flow path 62 connecting the peripheral outlet 77 and the peripheral inlet 47 may include a horizontal flow path 64 connected to the peripheral inlet 47 and a vertical flow path 63 connecting the horizontal flow path 64 and the peripheral outlet 77.

Then, both the electrolyte flowing into the main inlet 46 and ejected through the main outlet 74 and the electrolyte flowing into the peripheral inlet 47 and ejected through the peripheral outlet 77 may be vertically sprayed between the plurality of electrodes 32, and accordingly, air bubbles generated when power is applied to the substrate 12 and the plurality of electrodes 32 and electrochemical electrodeposition occurs may be more effectively removed.

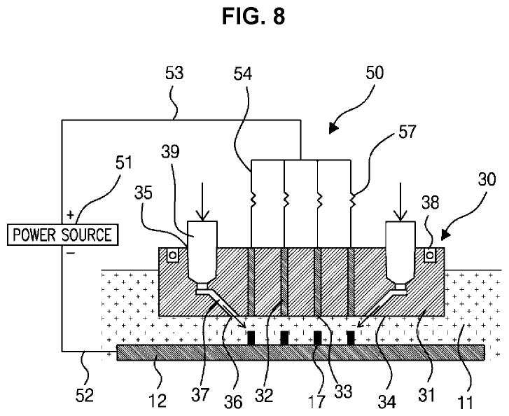

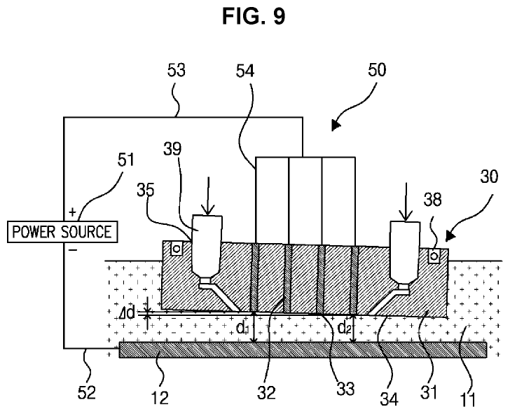

FIG. 8 is a diagram schematically showing a power supply according to another embodiment of the present disclosure, and FIG. 9 is a diagram for explaining an effect of the power supply of FIG. 8.

Referring to FIG. 8, the power supply 50 according to the present embodiment may include a resistance element 57 provided in the sub connector 54.

Then, when power is simultaneously applied to each of the substrate 12 and the plurality of electrodes 32, multi-stacking by each of the plurality of electrodes 32 may be stably performed.

As a method of applying power to the substrate 12 and the plurality of electrodes 32, a constant voltage method of applying the same voltage or a constant current method of applying the same current may be used. In this case, an electrolyte that is present in a gap between the bottom surfaces 33 of the plurality of electrodes 32 and the substrate 12 may act as resistance.

At this time, in order to stably perform multi-stacking by each of the plurality of electrodes 32, when power is simultaneously applied to each of the plurality of electrodes 32 and the substrate 12, a difference between current values or voltage values applied to each of the plurality of electrodes 32 needs to be within a predetermined range.

However, when power is simultaneously applied to each of the substrate 12 and the plurality of electrodes 32, a phenomenon in which current is concentrated on any one electrode of the plurality of electrodes 32 may occur. In this case, multi-stacking by each of the plurality of electrodes 32 may not be performed stably.

In addition, in order to ensure uniform multi-stacking by each of the plurality of electrodes 32, when power is applied to each of the substrate 12 and the plurality of electrodes 32, current values or voltage values applied to each of the plurality of electrodes 32 need to be the same, and to this end, distances between the bottom surfaces 33 of the plurality of electrodes 32 and the substrate 12 need to be the same.

However, as shown in FIG. 9, when the multi-electrode module 30 is tilted at a predetermined angle, distances d₁ and d₂ between each of the bottom surfaces 33 of the plurality of electrodes 32 and the substrate 12 may become different, and then, when power is simultaneously applied to each of the substrate 12 and the plurality of electrodes 32, current values or voltage values applied to each of the plurality of electrodes 32 may differ as much as a resistance value deviation due to a difference Δd of the distances d₁ and d₂.

Not only when the multi-electrode module 30 is tilted, but also due to various causes such as errors in manufacturing the multi-electrode module 30, external shocks, and foreign substances, the distances d₁ and d₂ between each of the bottom surfaces 33 of the plurality of electrodes 32 and the substrate 12 may be changed.

Like the power supply 50 according to the present embodiment, when the resistance element 57 is provided in the sub connector 54, if power is applied simultaneously to each of the substrate 12 and the plurality of electrodes 32, a phenomenon in which current is concentrated on any one of the plurality of electrodes 32 may be prevented, and furthermore, it may be possible to reduce a difference in current values or voltage values applied to each of the plurality of electrodes 32 from the resistance value deviation due to the difference Δd of the distances d₁ and d₂ between each of the bottom surfaces 33 of the plurality of electrodes 32 and the substrate 12.

In this case, a resistance value of the resistance element 57 may have a greater value than a resistance value between the substrate 12 and the bottom surfaces 33 of the plurality of electrodes 32.

In particular, a resistance value of the resistance element 57 may have a greater value than a resistance value between the bottom surfaces 33 of the plurality of electrodes 32 and the substrate 12 to the extent that a difference in current values or voltage values applied to each of the plurality of electrodes 32 caused by a difference in resistance value between the bottom surfaces 33 of the plurality of electrodes 32 and the substrate 12 is negligible.

For example, a resistance value of the resistance element 57 may have a value in the range of 5 to 15 times a resistance value between the bottom surfaces 33 of the plurality of electrodes 32 and the substrate 12, or a resistance value between the bottom surfaces 33 of the plurality of electrodes 32 and the substrate 12 may have a value in the range of 50 to 2000, and a resistance value of the resistance element 57 may have a value in the range of 250 to 3,0000.

Then, uniform stacking may be possible during multi-stacking by each of the plurality of electrodes 32.

Alternatively, the resistance value of the resistance element 57 may have a greater value than a resistance value deviation due to the difference Δd of the distances d1 and d2 between the bottom surfaces 33 of the plurality of electrodes 32 and the substrate 12.

For example, a resistance value of the resistance element 57 may have a value in the range of 5 to 15 times the resistance value deviation, or the resistance value deviation may have a value in the range of 20 to 900, and a resistance value of the resistance element 57 may have a value in the range of 100 to 1,350Ω.

Then, uniform stacking may be possible during multi-stacking by each of the plurality of electrodes 32.

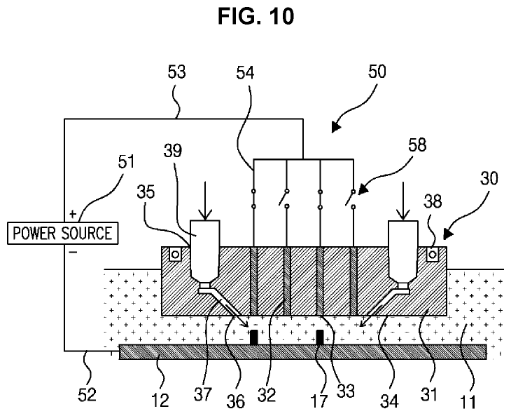

FIG. 10 is a diagram schematically illustrating a power supply according to another embodiment of the present disclosure.

Referring to FIG. 10, the power supply 50 according to the present embodiment may include a first switching part 58 provided in the sub connector 54 to selectively connect the main connector 53 and the electrodes 32.

In this case, on/off of the first switching part 58 may be controlled by the controller 14.

Then, when power is simultaneously applied to each of the substrate 12 and the plurality of electrodes 32, multi-stacking by each of the plurality of electrodes 32 may be selectively performed.

For example, according to control of the first switching part 58, multi-stacking may be performed by the electrodes 32 constituting any one column or row of the plurality of electrodes 32 arranged at a predetermined interval, multi-stacking may be performed by the electrodes 32 that are not adjacent to each other among the plurality of electrodes 32, or single-stacking may be performed on only one electrode among the plurality of electrodes 32.

Also, the plurality of electrodes 32 may include at least one or more electrodes having the bottom surfaces 33 with different sizes.

Since stacking by each of the plurality of electrodes 32 is formed on a region 17 of the substrate 12, which faces the bottom surfaces 33 of the electrodes 32 on the substrate 12, the region 17 may vary depending on the sizes of the bottom surfaces 33 of the electrodes 32.

Accordingly, when the plurality of electrodes 32 includes at least one or more electrodes having the bottom surfaces 33 with different sizes, if power is simultaneously applied to each of the substrate 12 and the plurality of electrodes 32, various types of multi-stacking may be performed.

For example, after the electrode 32 having the bottom surface 33 with a small size is placed in one row among the plurality of electrodes 32 arranged above, the electrode 32 having the bottom surface 33 with a large size is placed in another adjacent row, and the above arrangement is alternately and repeatedly performed, multi-stacking by the electrodes 32 having the bottom surfaces 33 with a large size may be performed according to control of the first switching part 58, and multi-stacking by the electrode 32 having the bottom surface 33 with a small size may be performed, or multi-stacking by the electrodes 32 having the bottom surfaces 33 with a large size and multi-stacking by the electrodes 32 having the bottom surfaces 33 with a small size may be performed simultaneously.

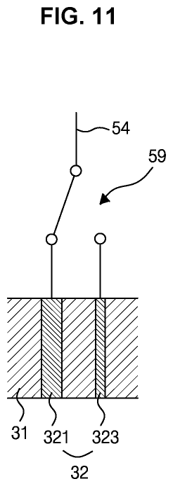

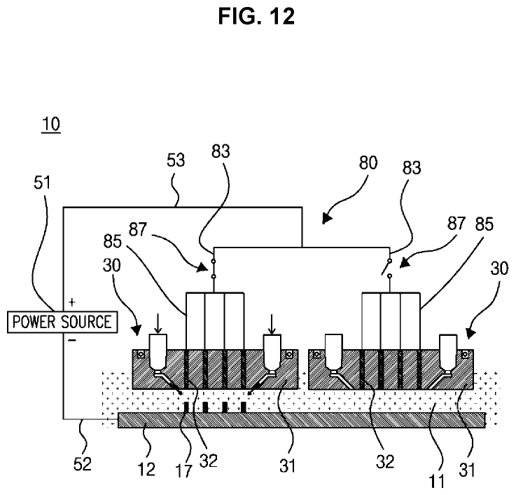

FIG. 11 is a schematic diagram of an electrode according to another embodiment of the present disclosure.

Referring to FIG. 11, at least one of the plurality of electrodes 32 may include a plurality of electrodes 321 and 323 having the bottom surfaces 33 with different sizes, and the sub connector 54 may include a second switching part 59 connecting any one of the plurality of electrodes 321 and 323 having the bottom surfaces 33 with different sizes to the main connector 53.

In this case, on/off of the second switching part 59 may be controlled by the controller 14.

Then, when power is applied to each of the substrate 12 and the plurality of electrodes 32 at the same time to perform multi-stacking, the size of a stacked electrode by each of the plurality of electrodes 32 according to control of the second switching part 59 may be different.

For example, according to control of the second switching part 59, some of the plurality of electrodes 32 are stacked by the electrode 321 having a large size among the plurality of electrodes 321 and 323 having the bottom surfaces 33 with different sizes, and other some of the plurality of electrodes 32 are stacked by the electrode 321 having a small size among the plurality of electrodes 321 and 323 having the bottom surfaces 33 with different sizes.

Therefore, according to the electrodes 32 according to an embodiment of the present disclosure, multi-stacking in more diverse forms may be possible.

FIG. 12 is a schematic diagram of a 3D printing device according to another embodiment of the present disclosure.

Referring to FIG. 12, the 3D printing device 10 according to the present embodiment may include a plurality of the multi-electrode modules 30 and a power supply 80 for supplying power to the plurality of multi-electrode modules 30.

Detailed descriptions of the multi-electrode module 30 and other components refer to the detailed descriptions in the above embodiments.

The power supply 80 may be provided to simultaneously apply power to each of the plurality of the multi-electrode module 30.

In detail, the power supply 80 may include the power source 51, the substrate connector 52 connecting the power source 51 to the substrate 12, the main connector 53 connecting the power source 51 to the plurality of electrodes 32, a first sub connector 83 connecting the main connector 53 and each of the plurality of the multi-electrode modules 30, and a second sub connector 85 connecting the first sub connector 83 and each of the plurality of electrodes 32.

Here, the first sub connector 83 may be provided such that the plurality of the multi-electrode module 30 is disposed in parallel to each other, and the second sub connector 85 may be provided such that the plurality of electrodes 32 is disposed in parallel to each other.

In addition, the power supply 80 may include a third switching part 87 provided in the first sub connector 83 to selectively connect the main connector 53 and the multi-electrode module 30.

In this case, on/off of the third switching part 87 may be controlled by the controller 14.

Then, when power is simultaneously applied to the substrate 12 and each of the plurality of multi-electrode modules 30, multi-stacking by each of the plurality of multi-electrode modules 30 may be selectively performed.

In this case, the second sub connector 85 may include the first switching part 58 selectively connecting the first sub connector 83 and the electrodes 32, and the resistance element 57, at least one of the plurality of electrodes 32 may include the plurality of electrodes 321 and 323 having the bottom surfaces 33 with different sizes, and the second sub connector 85 connecting any one of the electrodes 32 to the first sub connector 83 may include the second switching part 59 connecting any one of the plurality of electrodes 321 and 323 having the bottom surfaces 33 with different sizes to the first sub connector 83. Detailed descriptions of the first switching part 58, the resistance element 57, and the second switching part 59 may use the detailed descriptions in the above embodiments.

As described above, the present disclosure relates to a 3D printing device for selectively stacking a metal raw material on a substrate using an electrochemical additive manufacturing (ECAM) using electrochemical deposition, and the embodiments may be changed into various forms. Therefore, the present disclosure is not limited by the embodiments disclosed herein, and all forms changeable by those skilled in the art will also fall within the scope of the present disclosure.

1. A three-dimensional (3D) printing device comprising:
a tub accommodating an electrolyte;
a substrate placed in a state of being immersed in the electrolyte accommodated in the tub;
an electrode holder;
a multi-electrode module including a plurality of electrodes arranged and fixed at predetermined intervals on the electrode holder;
a driver configured to adjust movement of the multi-electrode module;
a power supply configured to supply power to the substrate and the plurality of electrodes; and
a controller configured to control the driver and the power supply to selectively electrodeposit and stack metal ions included in the electrolyte on the substrate.

2. The 3D printing device of claim 1, wherein the plurality of electrodes pass through the electrode holder, and bottom surfaces of the plurality of electrodes are level with a bottom surface of the electrode holder.

3. The 3D printing device of claim 1, further comprising:
a storage configured to store an electrolyte; and
an electrolyte feeder configured to supply the electrode stored in the storage to the tub,
wherein the electrode holder includes:
an inlet into which the electrolyte supplied from the electrolyte feeder flows;
an outlet through which the electrolyte supplied from the electrolyte feeder flows is ejected to the substrate; and
an ejection flow path connecting the inlet and the outlet; and
wherein the ejection flow path is inclined such that when the electrolyte introduced through the inlet is ejected through the outlet, the electrolyte is ejected toward a region in which the plurality of electrodes is provided.

4. The 3D printing device of claim 1, further comprising:
a storage configured to store an electrolyte; and
an electrolyte feeder configured to supply the electrode stored in the storage to the tub,
wherein the electrode holder includes:
an inlet into which the electrolyte supplied from the electrolyte feeder flows;
an outlet formed on a bottom surface of the electrode holder and formed between the plurality of electrodes to eject the electrolyte introduced through the inlet to the substrate; and
an ejection flow path connecting the inlet and the outlet.

5. The 3D printing device of claim 4, wherein the outlet includes:
a main outlet formed on a central part of a region in which the plurality of electrodes is provided; and
a peripheral outlet formed around the main outlet; and
wherein a main inlet connected to the main outlet is formed on a top surface of the electrode holder and formed on the central part of the region in which the plurality of electrodes is provided, and a peripheral inlet connected to the peripheral outlet is formed on a side surface of the electrode holder.

6. The 3D printing device of claim 1, wherein the power supply includes:
a power source;
a substrate connector connecting the power source to the substrate;
a main connector connecting the power source to the plurality of electrodes; and
a sub connector connecting the main connector to each of the plurality of electrodes.

7. The 3D printing device of claim 6, wherein the sub connector is provided such that the plurality of electrodes are arranged in parallel to each other.

8. The 3D printing device of claim 7, wherein the sub connector includes a resistance element.

9. The 3D printing device of claim 8, wherein a resistance value of the resistance element has a greater value than a resistance value between the substrate and bottom surfaces of the plurality of electrodes.

10. The 3D printing device of claim 9, wherein a resistance value of the resistance element has a value in a range of 5 to 15 times the resistance value between the substrate and the bottom surfaces of the plurality of electrodes.

11. The 3D printing device of claim 9, wherein the resistance value between the substrate and the bottom surfaces of the plurality of electrodes has a value in a range of 50 to 200Ω, and the resistance value of the resistance element has a value in a range of 250 to 3,000Ω.

12. The 3D printing device of claim 6, wherein the sub connector includes a first switching part selectively connecting the main connector and the electrodes.

13. The 3D printing device of claim 12, wherein:
at least one of the plurality of electrodes includes a plurality of electrodes having bottom surfaces with different sizes; and
a sub connector connecting the at least one of the plurality of electrodes to the main connector includes a second switching part connecting any one of the plurality of electrodes having bottom surfaces with different sizes to the main connector.

14. The 3D printing device of claim 12, wherein the sub connector includes a resistance element.

15. The 3D printing device of claim 1, wherein the multi-electrode module is provided in a plural number; and
wherein the power supply includes:
a power source;
a substrate connector connecting the power source to the substrate;
a main connector connecting the power source to the plurality of electrodes;
a first sub connector connecting the main connector to each of the plurality of electrodes; and
a second sub connector connecting the first sub connector to each of the plurality of electrodes.

16. The 3D printing device of claim 15, wherein the first sub connector is provided such that the plurality of multi-electrode modules are arranged in parallel to each other, and the second sub connector is provided such that the plurality of electrodes are arranged in parallel to each other.

17. The 3D printing device of claim 16, wherein the first sub connector includes a third switching part configured to selectively connect the main connector and the multi-electrode module.

18. The 3D printing device of claim 17, wherein the second sub connector includes a first switching part configured to selectively connect the first sub connector and the electrode.

19. The 3D printing device of claim 17, wherein the second sub connector includes a resistance element.

20. The 3D printing device of claim 17, wherein:
at least one of the plurality of electrodes includes a plurality of electrodes having bottom surfaces with different sizes; and
a second sub connector connecting the at least one of the plurality of electrodes to the first sub connector includes a second switching part connecting any one of the plurality of electrodes having bottom surfaces with different sizes to the first sub connector.
